(19) United States
(12) Patent Application Publication
(10) Pub. No.: US 2026/0329711 A1
(43) Pub. Date: Oct. 22, 2026

(54) APPARATUS, METHOD, AND COMPUTER PROGRAM FOR COLLECTING DIAGNOSTIC INFORMATION

(71) Applicant: ARM LIMITED, Cambridge Cambridgeshire (GB)

(72) Inventors: Michael John Williams, Cambridge (GB); Nigel John Stephens, Cambridge (GB); Alasdair Grant, Cambridge (GB)

(73) Assignee: Arm Limited, Cambridge (GB)

(21) Appl. No.: 19/157,562

(22) PCT Filed: Jan. 22, 2024
(86) PCT No.: PCT/GB2024/050166

§ 371 Date: Aug. 18, 2025

(30) Foreign Application Priority Data
Feb. 24, 2023 (GB) 2302661.0

(51) Int. Cl. G06F 11/30; G06F 9/38; G06F 11/34

(52) U.S. Cl. CPC G06F 11/302; G06F 9/3887; G06F 11/3075; G06F 11/3409; G06F 11/3466; G06F 2201/86; G06F 2201/865; G06F 2201/88

(57) ABSTRACT

An apparatus has processing circuitry to perform single instruction, multiple data (SIMD) processing on an array with a plurality of data items and the processing circuitry supports the SIMD processing for a plurality of array sizes. The processing circuitry is able to select an array size with which to perform the SIMD processing based on SIMD processing configuration information. Diagnostic information collection circuitry is provided to collect diagnostic information about software executing on the processing circuitry and the diagnostic information collection circuitry filters collection of the diagnostic information based on the SIMD processing configuration information.

The present technique relates to the field of data processing. More particularly, the present technique relates to collecting diagnostic information.

A data processing system may have diagnostic information collection circuitry to collect diagnostic information about software executing on processing circuitry. This diagnostic information can be used for example to analyse software performance to help identify parts of a software program that may be causing poor performance and possible reasons for any performance issues. The diagnostic information can be used by software engineers to optimise their software to reduce execution time and allow better utilisation of available resources in the data processing system.

At least some examples provide an apparatus comprising: processing circuitry operable to perform single instruction, multiple data (SIMD) processing on an array comprising a plurality of data items, the processing circuitry supporting the SIMD processing for a plurality of array sizes; wherein the processing circuitry is configured to select an array size with which to perform the SIMD processing based at least in part on SIMD processing configuration information; diagnostic information collection circuitry to collect diagnostic information about software executing on the processing circuitry; wherein the diagnostic information collection circuitry is configured to filter collection of the diagnostic information based on the SIMD processing configuration information.

At least some examples provide a computer-readable medium to store computer-readable code for fabrication of the apparatus mentioned above.

At least some examples provide a method for collecting diagnostic information, the method comprising: collecting the diagnostic information about software executing on processing circuitry; wherein the processing circuitry is operable to perform single instruction, multiple data (SIMD) processing on an array comprising a plurality of data items, the processing circuitry supporting the SIMD processing for a plurality of array sizes, wherein the processing circuitry is configured to select an array size with which to perform the SIMD processing based at least in part on the SIMD processing configuration information; and wherein collecting the diagnostic information comprises filtering collection of the diagnostic information based on the SIMD processing configuration information.

At least some examples provide a computer program comprising instructions which, when executed by a host data processing apparatus, control the host data processing apparatus to provide an instruction execution environment for executing target program code, the computer program comprising: processing program logic operable to perform single instruction, multiple data (SIMD) processing on an array comprising a plurality of data items, the processing program logic supporting the SIMD processing for a plurality of array sizes; wherein the processing program logic is configured to select an array size with which to perform the SIMD processing based at least in part on SIMD processing configuration information; diagnostic information collection program logic to collect diagnostic information about software executing on the processing program logic; wherein the diagnostic information collection program logic is configured to filter collection of the diagnostic information based on the SIMD processing configuration information.

At least some examples provide a computer-readable medium storing the computer program mentioned above. The computer-readable medium may be a non-transitory computer-readable storage medium.

Further aspects, features, and advantages of the present technique will be apparent from the following description of examples, which is to be read in conjunction with the accompanying drawings, in which:

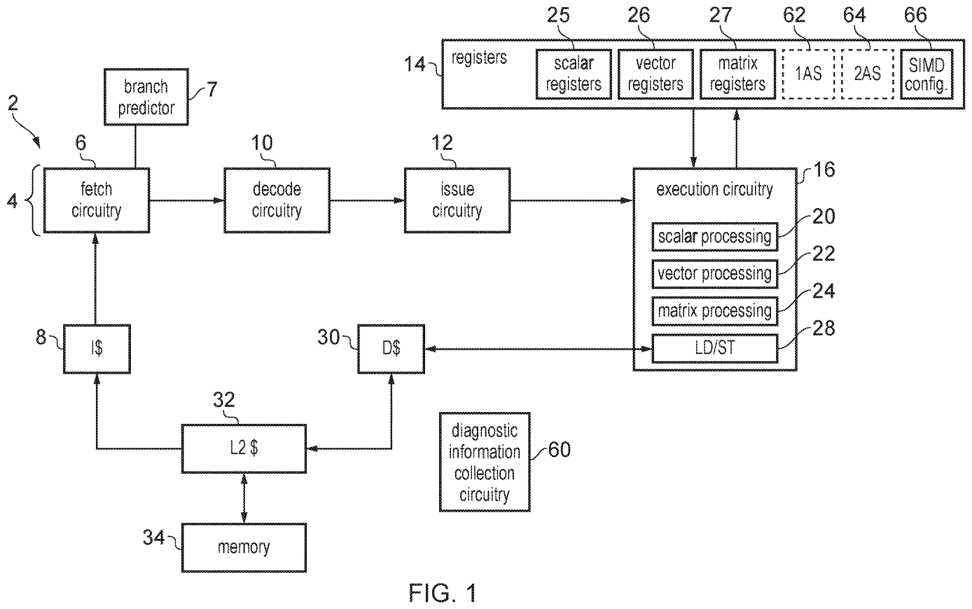

FIG. 1 illustrates an example of an apparatus having diagnostic information collection circuitry;

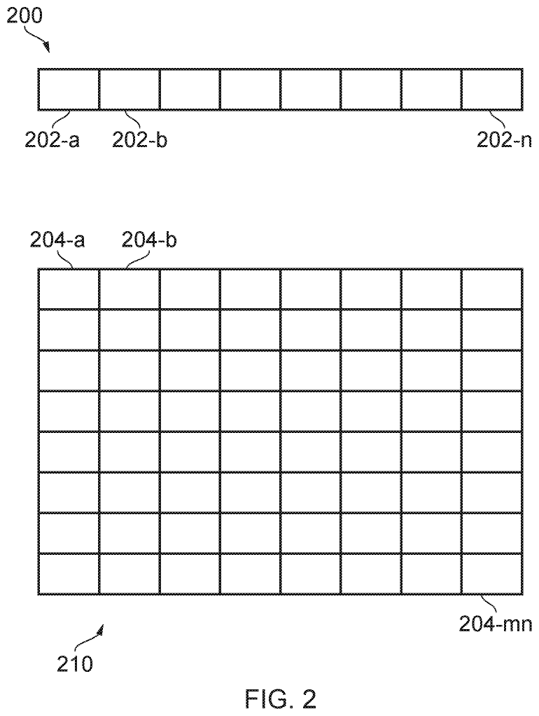

FIG. 2 illustrates examples of vector and matrix registers;

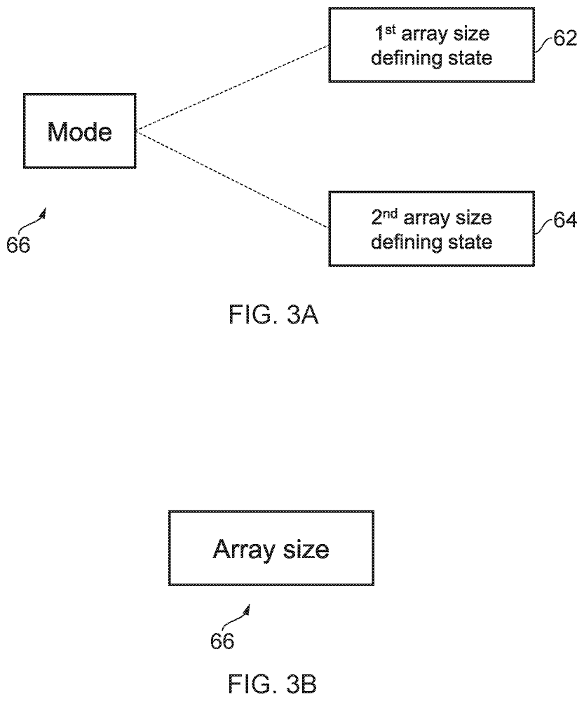

FIGS. 3A-3B illustrate examples of SIMD processing configuration information;

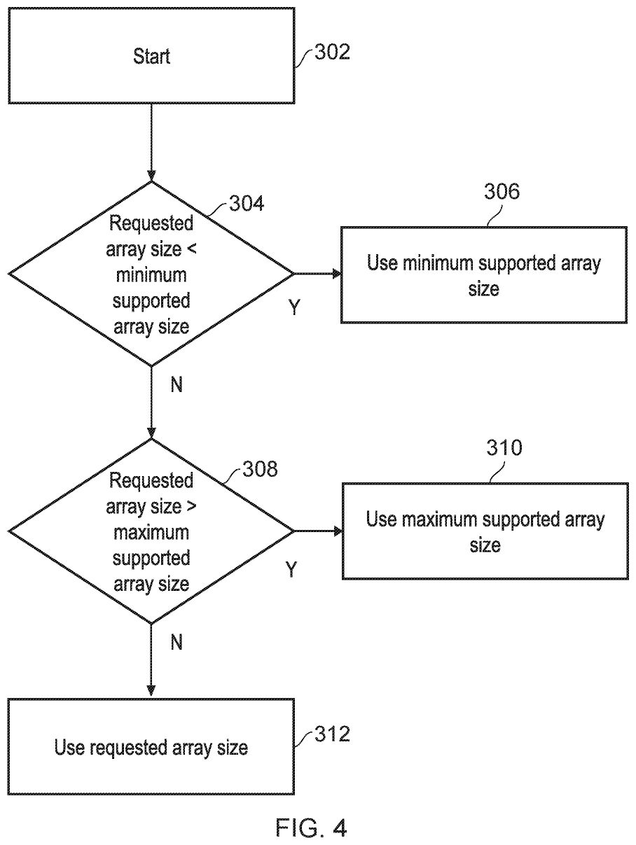

FIG. 4 is a flowchart illustrating a process to select an array size with which to perform SIMD processing;

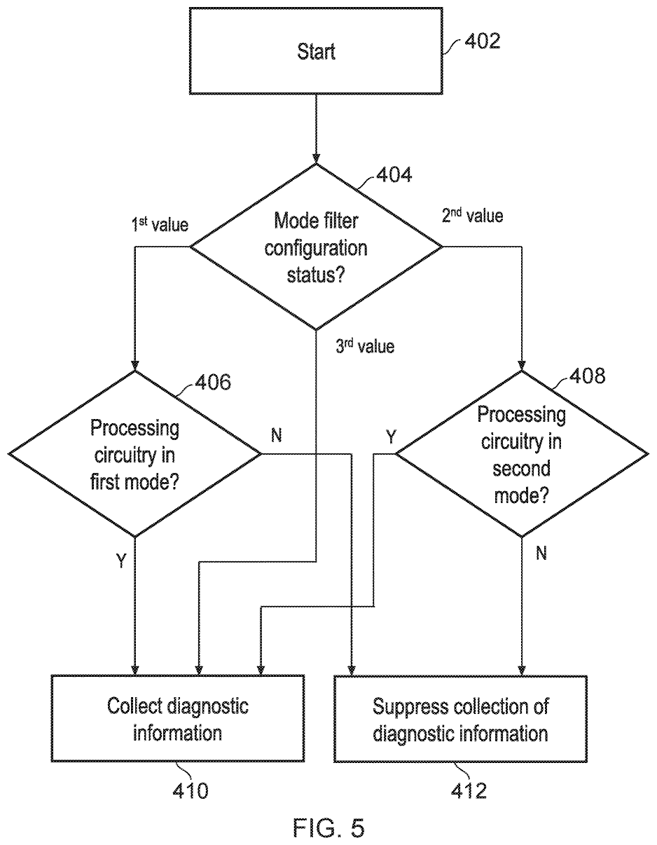

FIG. 5 is a flowchart illustrating a process in which the collection or suppression of diagnostic information is based on a mode of operation of processing circuitry;

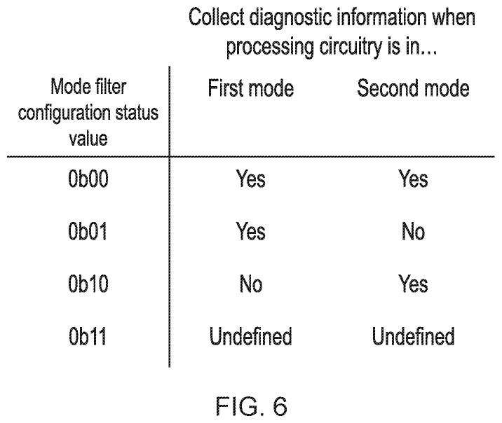

FIG. 6 is a table illustrating the dependence of the collection or suppression of diagnostic information on a mode of operation of processing circuitry;

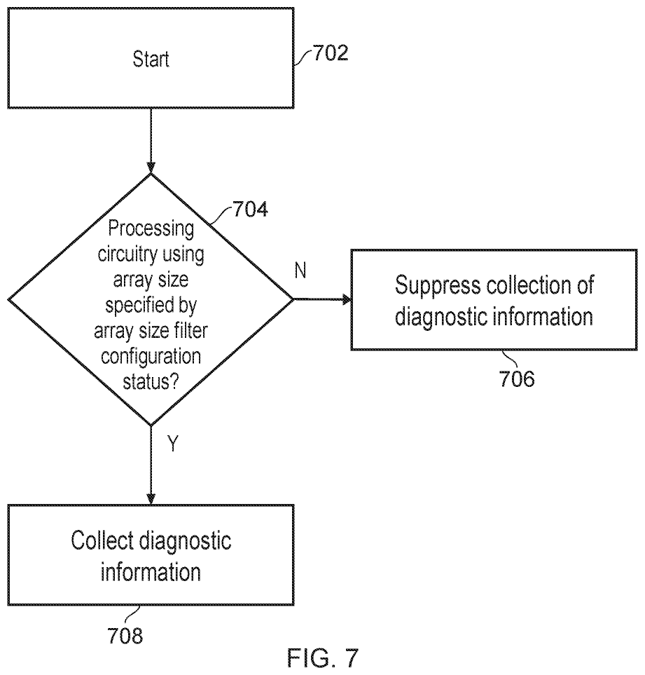

FIG. 7 is a flowchart illustrating a process in which the collection or suppression of diagnostic information is based on an array size specified by SIMD processing configuration information;

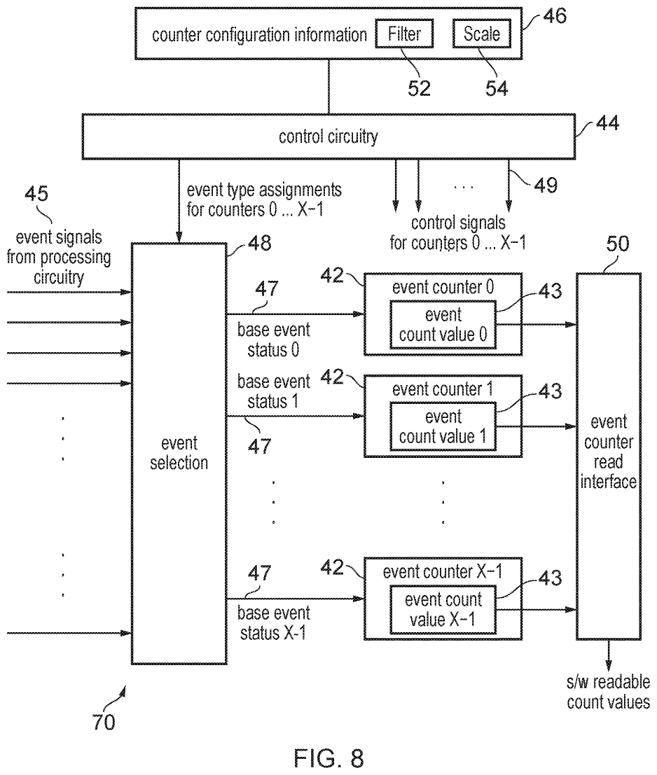

FIG. 8 illustrates an example of performance monitoring circuitry;

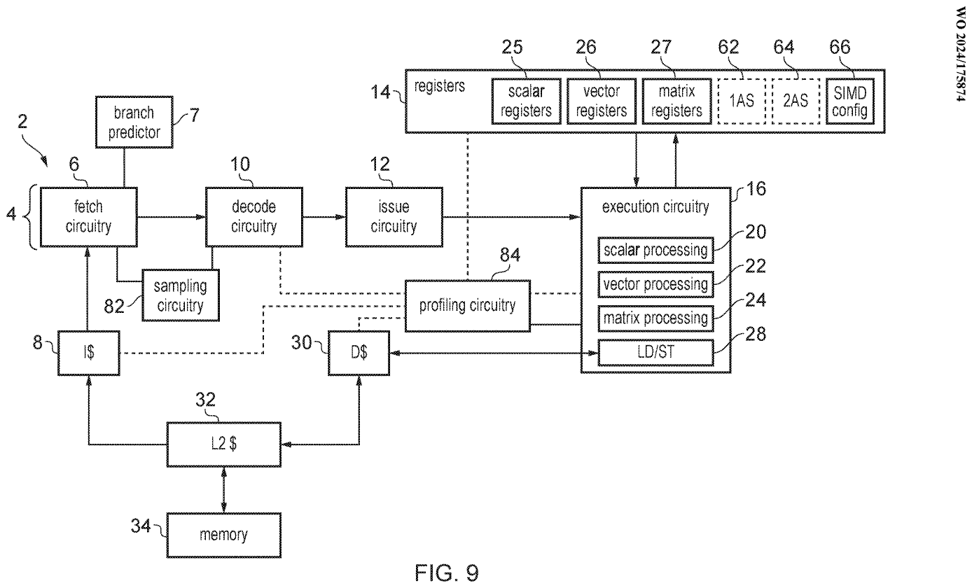

FIG. 9 illustrates an example of an apparatus having profiling circuitry;

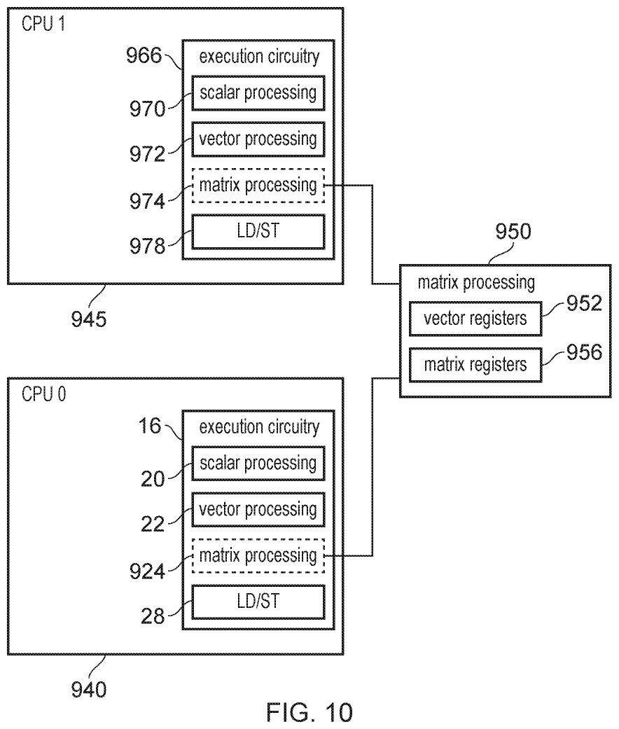

FIG. 10 illustrates an example of multiple processors sharing matrix processing circuitry; and

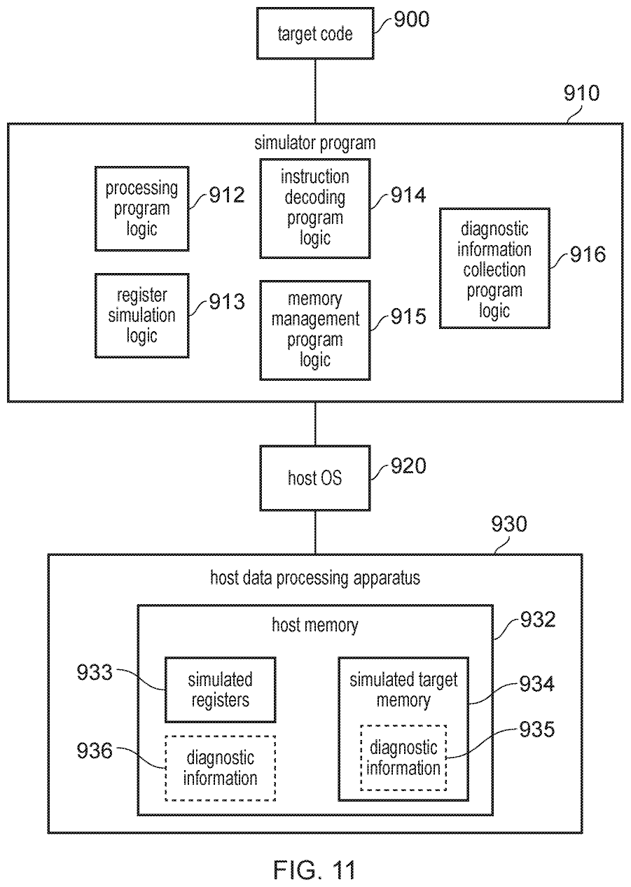

FIG. 11 illustrates a simulation example.

Before discussing the examples with reference to the accompanying figures, the following description of examples is provided.

In accordance with the techniques described herein, there is provided processing circuitry that is operable to perform single instruction, multiple data (SIMD) processing. Using SIMD processing, a single instruction can cause an operation to be applied to data across an array comprising a plurality of data items. The operations performed on the different data items may be performed simultaneously and in parallel using multiple processing elements although it should be appreciated that in some cases, the SIMD processing could be achieved using repeated execution by a single processing element (or more generally a smaller number of processing elements than the size of the array). In this sense, SIMD processing represents an architectural feature (i.e., an option available to be specified by program code) and micro-architectural implementations may or may not use multiple processing elements to implement the SIMD processing. Examples of SIMD processing include vector processing in which operations are performed on vectors comprising a plurality of elements logically arranged in one dimension or matrix processing in which operations are performed on matrices comprising a plurality of elements logically arranged in two dimensions, or in some cases vectors.

In accordance with the techniques described herein, the processing circuitry is configured to select an array size with which to perform SIMD processing based at least in part on SIMD processing configuration information. This SIMD processing configuration information may be accessible as a result of being stored in a memory-mapped register or in a system register that can be modified using software. This allows software, and hence a user, control over the array size that is used to perform the SIMD processing.

However, if diagnostic information were collected for the processing circuitry regardless of contents of the SIMD processing configuration information and hence regardless of the array size, certain insights into the performance of the processing circuitry could be lost. For example, if the diagnostic information were used to count the number of cycles taken to execute a particular algorithm using SIMD processing operations, the count could vary significantly depending on whether a small array size was used, in which case a large number of SIMD operations may be needed or whether a large array size was used, in which case a smaller number of SIMD operations may be required. Accordingly, being able to filter the collection of diagnostic information based on the array size being used can be useful for providing accurate insights into the operation of the apparatus, and particularly the operation of SIMD processing by the processing circuitry. Additionally, without any dependence on the array size being used, it may be difficult or even impossible to disaggregate diagnostic information collected for SIMD processing performed with a range of different array sizes. The diagnostic information associated with one array size may become obscured by the presence of diagnostic information collected during while another array size was used. For example, even if a number of SIMD processing operations performed were known as well as the array sizes used during a period of software execution, without knowing how many operations were performed in each mode, it may not be possible to determine a total number of data items operated on. For a software engineer aiming to examine the execution of software, this could prevent him/her from obtaining meaningful insights into the performance of the software.

In some cases, the software engineer may only be concerned with execution of software associated with particular values of the SIMD processing configuration information and so by filtering the diagnostic information collected based on this SIMD processing configuration information, he/she may be able to select only the information of interest.

In accordance with the techniques described herein, the apparatus is therefore provided with diagnostic information collection circuitry that is configured to filter collection of the diagnostic information based on the SIMD processing configuration information.

In some examples, filtering the collection of the diagnostic information comprises collecting the diagnostic information or suppressing the collection of diagnostic information in dependence on the SIMD processing configuration information. In some examples however, the filtering the collection of diagnostic information may take other forms. For example, basic diagnostic information may be collected regardless of the SIMD processing configuration information and the filtering may determine whether an additional level of diagnostic information is to be collected based on the SIMD processing configuration information.

The diagnostic information may take a number of possible forms but in some examples, the diagnostic information is indicative of one or more of:
cycle counts measuring latency of certain events during the processing of the sampled operation;
elapse of a clock cycle;
execution of an instruction (either any instruction in general, or an instruction of a specific type);
a memory access request being made (either any memory access in general, or memory accesses of specific types, e.g., loads or stores);
a cache access, cache linefill or cache miss occurring (in some cases, this could be specific to a particular level or type of cache);
a TLB access, TLB linefill or TLB miss occurring (again, this could be events tracked for any TLB in general, or could be specific to particular TLB instances (e.g. data-side TLB or instruction-side TLB) or particular TLB levels (e.g. level 1 or level 2));
a branch misprediction occurring;
a queue or buffer becoming full (variants of which can be provided for specific buffers such as an instruction issue queue, load buffer, store buffer, etc.); or
a stall of the pipeline occurring due to a particular cause (e.g. a cache miss, a TLB miss, or a load or store buffer becoming full);
a number of cycles taken to perform a page table walk for filling the TLB;
a number of cycles taken to service a linefill request to bring data into a cache following a cache miss; and
an indication of current occupancy of a particular queue or buffer.

It will be appreciated that this list is not exhaustive and that a wide variety of different aspects of the operation of processing circuitry could be monitored.

In some examples, the processing circuitry supports at least two modes of operation associated with SIMD processing with different array sizes. More specifically, the processing circuitry may be operable in a first mode of operation in which the processing circuitry performs SIMD processing with an array size (i.e., number of elements) determined based on first array size defining state and a second mode of operation in which the processing circuitry performs SIMD processing with an array size based on second array size defining state. In this case, the SIMD processing configuration information may be indicative of whether the SIMD processing circuitry is operating in the first mode of operation or the second mode of operation. Accordingly, the diagnostic information collection circuitry may filter the collection of the diagnostic information (e.g., determine whether to collect the diagnostic information or to suppress collection of the diagnostic information) based on whether the processing circuitry is operating in the first mode of operation or the second mode of operation. Thus, while the SIMD processing configuration information does not directly define the array size itself, the SIMD processing configuration information may be used indirectly to identify the array size to be used (e.g., by referencing the first/second array size defining state).

In addition to or instead of determining whether to collect the diagnostic information based on the mode of operation of the processing circuitry, the diagnostic information collection circuitry may include in the diagnostic information that is collected, an indication of the mode of operation in which the processing circuitry was operating during the period to which the diagnostic information relates. The indication of the mode of operation contained in the diagnostic information can be used to provide insights into the operation of software in the different modes of operation or to enable calculations of values that are dependent on the array size that was used for SIMD processing.

The diagnostic information collection circuitry may also be configurable such that the mode of operation for which diagnostic information is collected can be selected. To enable this, the apparatus is provided with mode filter configuration circuitry to store a mode filter configuration status. Based on the value of the mode filter configuration status, the diagnostic information collection circuitry may determine whether diagnostic information is to be collected or suppressed for each of the modes of operation. For example, the diagnostic information collection circuitry may be responsive to the mode filter configuration status having a first value to collect the diagnostic information when the processing circuitry is in the first mode of operation and to suppress collection of the diagnostic information when the processing circuitry is in the second mode of operation. Thus, the first value of the mode filter configuration status can be used to cause the diagnostic information collection circuitry to collect diagnostic information only when the processing circuitry is operating in the first mode of operation.

In some examples, the diagnostic information collection circuitry may be responsive to the mode filter configuration status having a second value to collect the diagnostic information when the processing circuitry is in the second mode of operation and to suppress collection of the diagnostic information when the processing circuitry is in the first mode of operation. Thus, the second value of the mode filter configuration status can be used to selectively collect diagnostic information only when operating in the second mode of operation.

With these techniques, it is therefore possible to select which mode of operation diagnostic information should be collected for and have diagnostic information collected only for that mode of operation. Thus, insights into the operation of software when executing in a particular mode of operation can be obtained. Since the modes of operation are associated with different array size defining state, this can be used to ensure that diagnostic information is not collected for SIMD processing carried out with an array size defined by different items of array size defining state, which could obfuscate the information collected.

In some instances, it may be desirable to collect the diagnostic information regardless of the mode of operation. To support this, the diagnostic information collection circuitry may be responsive to the mode filter configuration status having a third value to collect diagnostic information when the processing circuitry is in the first mode of operation or the second mode of operation. That is to say, the diagnostic information is therefore collected independently of the mode of operation.

It will be appreciated that the present techniques are not limited to examples in which only two modes of operation are used. Indeed, one or more additional modes of operation may be provided in which the array size to use for SIMD processing is defined based on one or more corresponding additional items of array size defining state.

In some examples, instead of or as well as specifying a mode of operation in the SIMD processing configuration information, the SIMD processing configuration information specifies an array size that is to be used. This may take the form of the array size being included in the SIMD processing configuration information or may be encoded (e.g., by a value that corresponds to a selection of a particular array size from a list of possible array sizes). The diagnostic information collection circuitry may then how to filter the diagnostic information based on the array size with which the SIMD processing was performed (as may be established using the SIMD processing configuration information).

To support filtering of the diagnostic information on the basis of a specified array size, the apparatus may comprise array size filter configuration storage circuitry to store an array size filter configuration status indicative of one or more array sizes for which diagnostic information is to be collected. The diagnostic information collection circuitry can then collect the diagnostic information in respect of SIMD processing performed using an array size of those one or more array sizes specified by the array size filter configuration status. Conversely, for SIMD processing performed using an array size that was not specified by the array size filter configuration status, the diagnostic information collection circuitry may be arranged to suppress collection of the diagnostic information.

One example of diagnostic information collection circuitry in which the present techniques may be implemented is performance monitoring circuitry. Performance monitoring circuitry is provided for monitoring the performance of software executing on processing circuitry. The performance monitoring circuitry comprises event counters each to maintain a respective event count value based on monitoring of events during processing of the software by the processing circuitry. There is also provided control circuitry to configure the event counters based on counter configuration information. The counter configuration information could include event type assignment information indicative of which types of event are assigned to be monitored by the event counters. Such performance monitoring circuitry can be useful to investigate possible causes of poor performance when software is executing on processing circuitry as the event count values can expose information about internal events occurring within the processing circuitry while the software is executing (such as cache misses, branch mispredictions, instruction stalls, buffers becoming full, etc.).

The configuration information may also comprise filter configuration information that can be used to select how the performance monitoring circuitry should filter updates to the event counters in dependence on the SIMD processing configuration information. Thus, the one or more of the event counters can be specific to events occurring, for example, in a particular mode of operation or with a particular array size or sizes. The performance monitoring circuitry may be responsive to the filter configuration information for a given event counter having a first value to update the given event counter for events occurring when the processing circuitry is in the first mode of operation and to suppress updates to the given event counter when the processing circuitry is in the second mode of operation or otherwise to filter the updates to the event counters based on the SIMD processing configuration information. Similarly the performance monitoring circuitry may be responsive to the filter configuration information for a given event counter specifying one or more particular array sizes, to update the given event counter for events occurring when the processing circuitry is performing SIMD processing with one of those particular array sizes and to suppress updates to the given event counter when a different array size is used. Thus, a count of events can be maintained relating to periods of interest, with events collected outside those periods disregarded for the count.

In some examples, the performance monitoring circuitry is operable to scale updates to the event counters by a scale factor before the event counter is updated. Where it is expected that the number of events to be counted is particularly large, scaling may be used to reduce the amount by which the count in an event counter needs to be updated, thereby reducing the chance of overflow of the event counter where the count becomes too high to be recorded by the event counter and reduces the requirement on circuitry that is provided to handle the event counters (e.g., by reducing the amount of circuitry required to add two counters together). Thus, the performance monitoring circuitry may be responsive to the counter configuration information specifying that a scale factor is to be applied for a particular event counter, to scale updates to that particular event counter.

In some examples, the scale factor may be dependent on the array size for which the processing circuitry is performing the SIMD processing. For example, the counter configuration information may configure a particular event counter to count the number of data items operated on. Where the processing circuitry performs SIMD processing, this number can become very large since a single instruction can lead to multiple items of data being operated on. As such, scaling may be used to scale the count maintained by the particular event counter by a scale factor to a more manageable size. This scale factor may be the size of the array being used to perform the SIMD processing. With this scaling in place, the event counter may be incremented by a number of SIMD operations performed. It might be possible to later undo the scaling to recover the number of elements operated on.

However, where the processing circuitry is operable with different array sizes, it may not be possible to properly recover the number of elements operated on since it is not known which array size was used when the events were recorded. Accordingly, by providing performance monitoring circuitry that is able to selectively filter events based on the SIMD processing configuration information, which is associated with the array size, the present techniques can allow event counters to be maintained which pertain to operations performed only for specified array sizes/modes of operation. This may enable the unscaled count (e.g., the number of data items operated on) to be recovered from the scaled counter.

Another situation in which the present techniques may be applied is for statistical profiling of software. To carry out software profiling, the apparatus may be provided with sampling circuitry to select a subset of instructions or micro-operations as sampled operations to be profiled. Profiling circuitry may also be provided to capture, in response to processing of an instruction or a micro-operation selected as a sampled operation by the sampling circuitry, a sample record comprising diagnostic information about behaviour of the sampled operation which is directly attributed to the sampled operation.

The information included in the sample record may directly indicate events that happened during the processing of the sampled operation, such as whether a cache miss in a given level of cache occurred or whether a branch misprediction occurred for a given branch, or may indicate cycle counts measuring latency of certain events during the processing of the sampled operation.

With this approach, as the sample record captures information directly attributed to the sampled operation, this avoids a “skid” problem which can arise with interrupt-based profiling mechanisms which use counters to count specific events such as cache misses or branch mispredictions which may impact on poor performance, and when a given number of such events have been detected, generate an interrupt to cause an exception handling routine to read out architectural state from registers or other diagnostic information, which can then be made accessible for diagnostic analysis. For such interrupt-based profiling mechanisms, there may be a “skid” delay between a time at which an interrupt is signalled to cause an exception handling routine to read out architectural state from registers or other performance monitoring information and the time at which the exception handler starts to gather the captured architectural state or diagnostic information.

As the sampling circuitry selects only a subset of the instructions or micro-operations as sampled operations this greatly reduces the hardware and power overhead in gathering the information on the sampled operations. The sample records captured for the sampled operations may provide a statistical view of performance of the program as a whole rather than attempting to capture the behaviour of every operation. Also, the provision of sampling circuitry to select specific instructions or micro-operations as sampled operations to be profiled can enable events occurring at different stages of the pipeline to be tracked as the sampled operation progresses through the pipeline, which may not be possible in examples where profiling is based on capture of architectural state or counters on occurrence of the specific event, where that information may not be directly attributable to a particular operation but could be based on multiple different operations.

The sampling circuitry and the profiling circuitry can be useful for providing detailed information on the outcomes and performance of particular operations being processed by the processing circuitry, which can be useful for identifying possible reasons for poor performance when executing a given program. However, another aspect of profiling may be to identify which portions of program code are executed more frequently than other portions. The software developer may only have a finite amount of time available for code optimization, and may wish to focus their time on improving performance for the more frequently executed portions of code in preference to less frequently executed sections of code.

To allow insights into the operation of the processing circuitry that are dependent on the array size used for SIMD processing, the profiling circuitry may be configured such that the collection of the sample records is dependent on the SIMD processing configuration information. The profiling circuitry may thus be configured to selectively filter the capture of a sample record based on the SIMD processing configuration information (e.g., whether the processing circuitry is in the first mode of operation or the second mode of operation or the array size being used).

The profiling circuitry may also include in the sample record, an indication of the SIMD processing configuration information such as the mode of operation of the processing circuitry when the sampled operation was processed or the array size being used. This approach would allow the collected information to be disaggregated based on the mode of operation/array size when the sample record was analysed.

Where the SIMD processing configuration information indicates a mode of operation to be used for SIMD processing, the first mode of operation and the second mode of operation may correspond to the use, by the processing circuitry, of different elements of circuitry to carry out the SIMD processing. So the processing circuitry may be configured to use first SIMD processing circuitry to perform the SIMD processing when in the first mode of operation and to use second SIMD processing circuitry to perform the SIMD processing when in the second mode of operation. This may for example correspond to the use of vector processing circuitry and matrix processing circuitry, both of which are able to perform SIMD processing. For example, one of the first SIMD processing circuitry and the second SIMD processing circuitry may be vector processing circuitry and the other of the first SIMD processing circuitry and the second SIMD processing circuitry may be matrix processing circuitry. The matrix processing circuitry may in some examples be operable to perform vector processing such that for vector processing operations, the processing circuitry is able to make use of either the vector processing circuitry or the matrix processing circuitry. However, the vector length (that is the array size) used by the vector processing circuitry and the matrix processing circuitry when performing vector processing is based on different pieces of vector length defining state and so may differ. Hence, by controlling the collection of diagnostic information in dependence on whether the vector processing circuitry or the matrix processing circuitry is used, relevant diagnostic information applicable to the SIMD processing circuitry being used can be obtained. In general however, the first and second SIMD processing circuitry need not correspond to matrix and vector processing circuitry. Both first and second SIMD processing circuitry could correspond to vector processing circuitry or to matrix processing circuitry, or to another form of SIMD processing circuitry.

In some micro-architectures, at least one of the first SIMD processing circuitry and the second SIMD processing circuitry may be shared between a plurality of processors (e.g., central processing units (CPUs), graphics processing units (GPUs), neural processing units (NPUs)). For example, a processor may be provided with vector processing dedicated for that processor as well as access to matrix processing circuitry that is shared with other processors.

The first and second array size defining state and the dependence of the array size on that state can take a number of forms. For example, the first and second array size defining state may be stored in respective registers or may be stored in different regions of the same register.

In some examples, the first and second array size defining state directly specify the array size that is to be used such that the processing circuitry performs the SIMD processing with the specified array size. However, in some examples, the array size defining state specifies a requested array size to be used. The actual array size used may however be additionally dependent on the array sizes supported by hardware and/or by software-configurable constraints on which array size or sizes may be selected.

Accordingly, the processing circuitry may be arranged, for a particular mode of operation, to determine the array size to use for SIMD processing based on the array size defining state for that mode by preferentially using the requested array size. However, if the requested array size is not suitable as it falls outside either a software-configured or hardware imposed maximum/minimum supported array size, the processing circuitry may use a different array size that is supported for that mode of operation.

Thus there has been described an apparatus that can support SIMD processing with a range of array sizes with the array size to use controlled using SIMD processing configuration information. Accordingly, the array size used for carrying out SIMD processing may differ. To avoid the use of different array sizes obscuring diagnostic information collected by diagnostic information collection circuitry, the collection of the diagnostic information may be made contingent on the array size being used, or more generally, the SIMD processing configuration governing the array size to use.

An apparatus may comprise the processing circuitry and diagnostic information collection circuitry mentioned above as well as either or both of the first SIMD processing circuitry and the second SIMD processing circuitry.

A computer-readable medium may store computer-readable code for fabrication of the apparatus mentioned above. As described further below, this can provide an electronic representation of the circuit design, which can be disseminated to another party to enable that party (or a further party downstream in the manufacturing chain) to manufacture the apparatus.

The techniques discussed above may be implemented using hardware circuitry provided for implementing the processing circuitry and diagnostic information collection circuitry discussed above.

However, the same technique can also be implemented within a computer program which executes on a host data processing apparatus to provide an instruction execution environment for execution of target program code. Such a computer program may control the host data processing apparatus to simulate the architectural environment which would be provided on a hardware apparatus which actually supports target code according to a certain instruction set architecture, even if the host data processing apparatus itself does not support that architecture. The computer program may have processing program logic which emulates functions of the processing circuitry discussed above and diagnostic information collection logic which emulates functions of the diagnostic information collection circuitry discussed above. Such a simulation can allow software development of target program code (e.g. debugging software intended for an apparatus having processing circuitry and diagnostic information collection circuitry discussed above) to start before the hardware having the processing circuitry and/or diagnostic information collection circuitry is actually ready. By executing the target program code on the simulated execution environment, this can enable testing of the target code in parallel with ongoing development of the hardware devices supporting the new features of the performance monitoring circuitry. The simulation program may be stored on a storage medium, which may be a non-transitory storage medium.

Particular examples will now be described with reference to the figures.

FIG. 1 illustrates an example of an apparatus 2 having diagnostic information collection circuitry 60. The data processing apparatus has a processing pipeline 4 which includes a number of pipeline stages, each implemented by corresponding circuity. In this example, the pipeline stages include a fetch stage 6 for fetching instructions from an instruction cache 8. A branch predictor 7 is also provided to prediction outcomes of branch instructions which can be used by the fetch stage 6 to decide which instructions to fetch beyond a branch. The pipeline stages also include a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values. The result values can then be written-back to the register file 14. It will be appreciated that this is merely one example of a possible pipeline arrangement, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar processing unit 20 (e.g. comprising a scalar arithmetic/logic unit (ALU) 20 for performing arithmetic or logical operations on scalar operands read from the registers 14); a vector processing unit 22 for performing vector operations on vectors comprising multiple data elements; a matrix processing unit 24 for performing matrix operations on vectors and matrices; and a load/store unit 28 for performing load/store operations to access data in a memory system 8, 30, 32, 34. Here, the vector processing unit 22 and matrix processing unit 24 each represent examples of SIMD processing circuitry. The matrix processing unit 24, as well as being able to perform matrix processing on matrix inputs is also operable to perform vector processing. In some examples, the matrix processing unit 24 provides all the functionality of the vector processing unit 22; however, it may be that the matrix processing unit 24 implements only a subset of the vector processing operations that are supported by the vector processing unit 22. Other examples of processing units which could be provided at the execute stage could include a floating-point unit for performing operations involving values represented in floating-point format, or a branch unit for processing branch instructions.

The apparatus 2 also includes diagnostic information collection circuitry 60 to collect diagnostic information about the operation of the apparatus 2. The diagnostic information may for example include information about cache misses, branch mispredictions, instruction stalls, buffers becoming full, counts of instructions executed/operations performed, etc.

The registers 14 include scalar registers 25 for storing scalar values, vector registers 26 for storing vector values, and matrix registers 27 for storing matrix values. The register file 14 also contains a SIMD processing configuration information register 66 to store SIMD processing configuration information.

The SIMD processing configuration information may in some cases be indicative of a mode of operation such that, when operating in a first mode of operation, the apparatus 2 is configured to perform vector processing 22 using vector processing unit 22 and when operating in a second mode of operation, as indicated by the SIMD processing configuration information 66, the apparatus is configured to use the matrix processing unit 24 for vector processing. In such a case, the register file 14 also contains a first array size defining state register 62 containing first array size defining state that specifies an array size to be used by the vector processing unit 22. The register file 14 also contains a second array size defining state register 64 containing second array size defining state that specifies an array size to be used by the matrix processing unit 24.

In some cases, the SIMD processing configuration information 66 may directly specify the array size to be used when performing SIMD processing, either using the vector processing unit 22 or the matrix processing unit 24.

As shown in FIG. 1, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline arrangement, and the processor may include many other elements not illustrated for conciseness.

FIG. 2 illustrates examples of a vector register 200 and a matrix register 210. The vector register 200, comprises a plurality of elements 202-a, 202-b, . . . 202-n (referred to collectively as elements 202). Each element 202 may be used to store a separate data item. The vector and/or matrix processing units can then operate on the vector 200 as a whole, applying an operation individually to data items across the elements 202 of the vector 200. While the operation may in some cases be applied to all elements 202 of the vector 200, in some cases, predication may also be employed to allow the operation to be selectively applied to only some of the elements 202 of the vector 200 in dependence on the value of a predicate stored in a predicate register. Matrix register 210 also comprises a plurality of elements 204-a, 204-b, . . . 204-mn (referred to collectively as elements 204) where each element 204 may be used to store a separate data item. The matrix processing unit 24 may operate on vector and/or matrix data, again performing operations on the data items in the respective element 204.

FIGS. 3A and 3B schematically illustrate possible forms of the SIMD processing configuration information 66. As shown in FIG. 3A, the SIMD processing configuration information 66 comprises SIMD mode information indicative of which of a first mode of operation and a second mode of operation the processing circuitry 4 is operating in. When the processing circuitry 4 is operating in the first mode of operation, the array size used by the processing circuitry 4 is specified by first array size defining state 62 and when the processing circuitry 4 is operating in the second mode of operation, the array size used by the processing circuitry 4 is specified by second array size defining state 64.

In FIG. 3B, an example is shown in which the SIMD processing configuration information 66 specifies the array size. The array size may be stored in the SIMD processing configuration information register 66 or may otherwise be indicated by the SIMD processing configuration information register 66.

FIG. 4 is a flowchart illustrating a process to select an array size with which to perform SIMD processing. The array size may correspond to a vector length to be used for vector processing or matrix dimensions to be used in matrix processing. After starting at step 302, the processing circuitry 4 determines whether a requested array size requested by software (e.g., by setting a value in a requested array size register or by indicating the requested size in field of an instruction) is smaller than a minimum supported array size. The minimum supported array size may be a minimum size set by software or may be a minimum array size that is supported by the hardware which is to perform the SIMD processing.

If the requested array size is smaller than (or equal to) the minimum supported array size, the processing circuitry 4 uses at step 306, as the array size for the operation, the minimum supported array size.

If the requested array size is greater than the minimum array size, flow proceeds to step 308 at which it is determined whether the requested array size is larger than a maximum supported array size. If the requested array size is greater than the maximum supported array size, then flow proceeds to step 310 at which the maximum supported array size is used. Otherwise, the requested array size is used at step 312.

FIG. 5 is a flowchart illustrating a process in which the collection or suppression of diagnostic information is based on a mode of operation of processing circuitry 4. After the process starts at step 402, the mode filter configuration status is inspected at step 404. The mode filter configuration status allows a selection of the modes of operation for which diagnostic information should be collected to be made.

If the mode filter configuration status has a first value (indicating that diagnostic information should be collected only for the first mode of operation), flow proceeds to step 406 at which it is determined whether the processing circuitry 4 is operating in the first mode of operation. If the processing circuitry 4 is operating in the first mode of operation, flow proceeds to step 410 at which the diagnostic information is collected. On the other hand, if the processing circuitry 406 was operating in a mode of operation other than the first mode of operation, flow proceeds to step 412 which corresponds to suppressing collection of the diagnostic information.

If the mode filter configuration status, as inspected at step 404, instead had a second value, flow proceeds to step 408 at which it is determined whether the processing circuitry is operating in the second mode of operation. If the processing circuitry 4 is operating in the second mode of operation, flow proceeds to step 410 at which the diagnostic information is collected. On the other hand, if the processing circuitry 406 was operating in a mode of operation other than the second mode of operation, flow proceeds to step 412 which corresponds to supressing collection of the diagnostic information.

In case the mode filter configuration status had a third value, used to indicate that diagnostic information should be collected regardless of the mode of operation, flow proceeds to step 410 at which the diagnostic information is collected, without checking which mode the processing circuitry 4 is operating in.

FIG. 6 is a table illustrating the dependence of the collection or suppression of diagnostic information on a mode of operation of processing circuitry 4. As illustrated in the table, the mode filter configuration status may be implemented using two bits, thereby providing four possible values for the mode filter configuration status. When the mode filter configuration status has the value 0b00, the diagnostic information collection circuitry is arranged to collect the diagnostic information regardless of the mode in which the processing circuitry 4 is operating. When the mode filter configuration status has the value 0b01, the diagnostic information collection circuitry is configured to collect the diagnostic information only when the processing circuitry 4 is operating in the first mode and hence suppresses collection of the diagnostic information when the processing circuitry 4 is operating in the second mode. When the mode filter configuration status has the value 0b10, the diagnostic information collection circuitry collects the diagnostic information only when the processing circuitry 4 is operating in the second mode (and not when the processing circuitry 4 is operating in the first mode). Thus, the dependence of the collection of diagnostic information collection on the mode of operation of the processing circuitry 4 can be controlled using the mode filter configuration status. When the mode filter configuration status has the final possible value, 0b11, in this case, the behaviour of the diagnostic information collection circuitry is undefined.

FIG. 7 is a flowchart illustrating a process in which the collection or suppression of diagnostic information is based on an array size specified by SIMD processing configuration information. In this example, after starting at step 702, at step 704 the array size being used by the processing circuitry 4 to carry out SIMD processing is compared with one or more array sizes specified by an array size filter configuration status that indicates for which array sizes diagnostic information is to be collected.

The array size filter configuration status could indicate for which array sizes diagnostic information is to be collected in a number of ways. For example, the array size filter configuration status could be a bitmap with each bit indicating whether a corresponding array size is enabled/disabled for diagnostic info capture, or could indicate a size threshold to specify whether diagnostic capture is enabled/disabled depending on a comparison of the current array size with the threshold.

If the processing circuitry 4 is using an array size specified by the array size filter configuration status (as may be established by comparing the SIMD processing configuration information and the array size filter configuration status), diagnostic information is collected for the processing at step 708. Otherwise, the collection of diagnostic information is suppressed at step 706.

It should be appreciated that the collection/suppression of diagnostic information as described with reference to FIGS. 5-7 represents an example of the way in which the collection of diagnostic information may be filtered. In other examples, some basic diagnostic information is generated regardless of the SIMD processing configuration information (e.g., the mode of operation) with additional diagnostic information, which may for example provide more detailed information, selectively generated based on the SIMD processing configuration information.

FIG. 8 illustrates performance monitoring circuitry, which represents an example of diagnostic information collection circuitry 60 to which the present techniques may be applied. As shown in FIG. 8, the performance monitoring circuitry 70 includes a number of event counters 42 which each maintain a corresponding event count value 43. The performance monitoring circuitry also includes control circuitry 44, which configures how the event counters behave, based on counter configuration information 46 set by a user. For example, the counter configuration information 46 could be state information stored in registers 14 of the processor (e.g. system registers), could be stored in memory-mapped registers implemented as distinct hardware separate from the memory system 30, 32, 34, or stored within the memory system 30, 32, 34 itself (in the case of memory-mapped registers or a data structure in memory itself being used to provide the counter configuration information, the control circuitry 44 may access those registers/structure based on a base address that is programmable by the user). Hence, in general a programming interface is provided to allow a user (e.g. a software developer performing debugging) to program the counter configuration information 46 so that the event counters 42 can be configured to gather various types of performance monitoring information of interest when debugging a particular program running on the processing circuitry 4. For example, debugging software may be executed to set the counter configuration information. The target program being debugged can then be executed. During execution of the target program, the performance monitoring circuitry 70 functions according to the previously set counter configuration information.

The performance monitoring circuitry 70 includes event selection circuitry 48 which receives from the processing circuitry 4 or other parts of the data processing system 2 a number of event signals 45 which indicate the status of a corresponding type of event. Although shown as a single logic block in FIG. 8, the event selection circuitry may comprise a separate event selector for each event counter, which independently selects the event signal 45 to be monitored by the corresponding event counter.

For example, event signals could be generated to indicate a wide variety of types of information about various components of the data processing apparatus 2.

Some event signals may indicate the occurrence of a specific action (or a count of how many times that action has occurred). For example, such an action may include any of:
elapse of a clock cycle;
execution of an instruction (either any instruction in general, or an instruction of a specific type);
a memory access request being made (either any memory access in general, or memory accesses of specific types, e.g. loads or stores);
a cache access, cache linefill or cache miss occurring (in some cases, this could be specific to a particular level or type of cache);
a TLB access, TLB linefill or TLB miss occurring (again, this could be events tracked for any TLB in general, or could be specific to particular TLB instances (e.g. data-side TLB or instruction-side TLB) or particular TLB levels (e.g. level 1 or level 2));
a branch misprediction occurring;
a queue or buffer becoming full (variants of which can be provided for specific buffers such as an instruction issue queue, load buffer, store buffer, etc.); or
a stall of the pipeline occurring due to a particular cause (e.g. a cache miss, a TLB miss, or a load or store buffer becoming full).

Other event signals may specify quantitative information providing a quantitative status value indicating a property of an event that has occurred, such as:
a number of cycles taken to perform a page table walk for filling the TLB;
a number of cycles taken to service a linefill request to bring data into a cache following a cache miss; or
an indication of current occupancy of a particular queue or buffer.

It will be appreciated that the lists of event types above are not exhaustive and that a wide variety of different event types could be monitored.

The counter configuration information 46 includes event type assignment information which specifies the event type to be monitored by each event counter 42. For example, each event counter 42 may have a corresponding event type field within the counter configuration information which has an encoding selecting which of the event signals 45 to use for a particular event counter 42. For each event counter, the event selection circuitry 48 selects, based on the event type assignment information for that counter, one of the event signals 45 which is passed to the corresponding event counter 42 as an event status indication 47 representing the status of the event assigned to that event counter 42 by the counter configuration information 46.

The counter configuration information 46 also includes filter configuration information 52 to allow the user to filter updates to the event counters 42 based on the SIMD processing configuration information that defines the array size to use. The filter configuration information 52 may, for example, use the encoding shown in FIG. 6 to indicate, for a particular event counter 42 to which an item of mode filter configuration information 52 relates, for which mode or modes of operation the performance monitoring circuitry 70 is to count events. When the processing circuitry 4 is operating in a mode of operation for which the mode filter configuration information 52 indicates that counts are to be suppressed (or otherwise filtered), the performance monitoring circuitry 70 refrains from incrementing the event count value 43 of the relevant event counter or counters 42. The filter configuration information 52 may also or alternatively specify certain array sizes for which updates to the event counters 43 are to be made such that updates to the event counters 43 associated with other array sizes are suppressed.

The counter configuration information 46 also includes scale configuration information 54 which the user can use to indicate a scale factor that is to be applied to counts. Based on the scale configuration information 54, the performance monitoring circuitry 70 can adjust an amount by which an event counter 42 is to be updated. Thus, where it is anticipated that the event count will need updating by a large amount or that the event count is likely to be particularly high, the count may for example be scaled down to avoid overflowing the event counter 42 and to reduce the requirements on downstream circuitry that operates on the event count values. The scale factor may in some cases be dependent on the array size with which the processing circuitry is operating. For example, if a count of the number of data items operated on were maintained while performing SIMD processing, to avoid overly large updates to the event count value, the count may be scaled by an array size used by the processing circuitry. This could be a convenient way to scale the count since the performance monitoring circuitry 70 would need to count only the number of SIMD operations performed by the processing circuitry. However, where different array sizes were used by the processing circuitry in the course of performing the SIMD processing, recovery of the number of data items operated on from the scaled count could become difficult or impossible. Accordingly, application of the scale factor may be used in combination with the filter so that events are only counted in a particular mode of operation or using a particular array size, allowing the information of interest to be more easily recovered from the scaled count.

For each event counter 42, a set of hardware circuit logic is provided including storage circuitry for storing the corresponding event count value 43 and counter control logic circuitry (implemented in hardware) for updating the event count value as a function of the event status indication 47 provided to that counter 42 by the event selection circuitry 48. For example, an increment value may be selected as a function of the event status indication 47 and a new value of the event counter value 43 may be calculated by adding the increment value to the previous value of that event counter value 43. Control signals 49 may be provided to each event counter 42 by the control circuitry 44, based on the counter configuration information 46. These control signals 49 may configure how a given counter selects the function to be applied to the event status indication 47 and how the increment value is to be selected based on the result of applying the function to the event status indication 47.

The performance monitoring circuitry 70 provides an event counter read interface 50 which allows software to read the event count values for each counter 42. For example, the read interface 50 may be provided by exposing each event count value 43 to the software as system registers which can be read by system register read instructions executed by the processing circuitry 4. Alternatively, the event count values 43 of each event counter 42 may be exposed through a memory-mapped interface so that they can be read by the software executing load instructions specifying memory addresses mapped to the storage locations storing the respective event count values 43. Either way, debugging software can read the current values of each event count value to determine information about what has happened when target software was being processed by the processing circuitry. In use, for example, the debugging software may use breakpoints or watchpoints to trigger an exception when the target software has reached the desired point at which investigation is required (e.g. a desired instruction address reached in program flow, or a desired data address accessed by a memory access instruction), and then when the exception is triggered, an exception handler provided by the debugging software can read out the event count values 43 and analyze the information provided by each event count value 43 to determine what has happened. This can be useful for diagnosing potential performance inefficiencies in the program code, to help identify possible improvements that could be made to the program code being executed to allow it to run more efficiently.

FIG. 9 illustrates an example of an apparatus 2 having profiling circuitry with which the present techniques may be implemented. Many of the elements of FIG. 9 were present in FIG. 1 and a full discussion of those elements will not be repeated here.

To assist with software development, the apparatus 2 is provided with hardware resources which allow gathering of profiling information about the behaviour of instructions processed by the processing pipeline 4, which a software developer can use to perform code optimization with the aim of modifying their code to run more efficiently. Sampling circuitry 82 is provided to select certain instructions or micro-operations as sampled operations to be profiled by profiling circuitry 84. The sampling circuitry 82 can select the sampled operations at different stages of the pipeline. For example, the sampling circuitry 82 may select certain fetched instructions as sampled operations and tag those fetched instructions at the fetch stage 6 to label those instructions to indicate that, as the instruction progresses down the pipeline 4, the profiling circuitry 84 should gather information on the behaviour of the sampled operation. Alternatively, the tagging of instructions of sampled operations by the sampling circuitry could take place at the decode stage 10 or at a later stage. Also it is possible that sampled operations are selected at the granularity of individual micro-operations rather than at the granularity of the architectural program instructions fetched from memory.

The sampling circuity may use an interval counter for counting instructions or micro-operations to determine when the next sampled operation should be selected. The sampling interval could be defined by a user-configurable parameter in a control register, or could be fixed to a particular interval. The interval counter counts the number of operations processed by the processing circuitry 4. The counted operations could either be fetched instructions, decoded instructions or decoded micro-operations. If the sample interval has elapsed then the next operation (e.g. fetched instruction, decoded instruction or decoded micro-operation) is tagged as a sample operation. For example, a tag bit associated with instruction may be set, and this tag bit may accompany instruction or micro-operation selected as the sampled operation as it progresses down the pipeline 4. The sampling circuitry 82 then resets the counter once more based on a new sampling interval.

An advantage of selecting only a subset of operations as a sampled operation is that this greatly reduces the overhead in tracking information for profiling. For example, the sampling interval could be set to be long enough that in practice only a single operation in flight within the pipeline 4 is selected as a sampled operation at a time, so that the profiling circuitry 84 need only be provided with sufficient hardware resources to track behaviour of a single sampled operation at a time. This avoids the overhead of having to index storage structures which can store information for multiple operations, based on an operation identifier associated with a particular sampled operation, to select which entry of the storage structure to update based on information for the particular sampled operation.

Nevertheless, other implementations may choose to incur a greater hardware cost and may choose to support multiple sampled operations being selected at a time. In those embodiments, the sampling of a subset of operations as sampled operations still has the advantage of greatly reducing the amount of profiling information generated compared to implementations which will attempt to track every instruction, making it feasible for a wider range of data to be captured for each sampled operation and hence for more meaningful profiling analysis to be performed.

The profiling circuitry 84 is configured to gather information about the behaviour of sampled operations selected by the sampling circuitry 82. The monitoring circuitry may include event detection circuitry to detect occurrence of various types of events for a sampled operation. The types of events detected may depend on the type of sampled operation. For example, for a branch operation selected as a sampled operation, the events could track whether a branch misprediction occurred or whether the branch predictor 7 correctly predicted the branch. For load/store operations the events could include, for example, whether the load/store operation missed in a certain level of cache 30, 32, whether the address translation lookup for the load/store instruction missed in a TLB or in a particular level of TLB, or whether an address fault occurred for the load/store instruction. Other types of events which may be monitored may be instruction fetches missing in the instruction cache 8, faults such as an undefined instruction exception, or whether certain instructions were delayed due to contention for resources. The monitoring circuitry may also capture information about particular instructions, such as the instruction address of the sampled operation, a target address of a load/store operation or a branch target address of a branch operation, and items of architectural state from the registers 14 that are captured at the point when the sampled operation reaches a certain stage of processing (for example, context identifiers identifying the processing context in which the sampled operation was processed). The monitoring circuitry may also have cycle counters which count the number of processing cycles taken for certain operations to complete, such as measuring the latency of an address translation or cache lookup, or the number of cycles for an operation to progress between a first point of processing and a second point of processing, for example. Hence, it will be appreciated that a variety of information can be gathered by the monitoring circuitry.

The captured monitoring information can be recorded in a sample record stored in sample record storage circuitry (e.g. registers or a buffer) of the profiling circuitry 84. Within a sample record captured for a given sampled operation, the record may specify the type of operation associated with the sampled operation (e.g. whether it is a branch, a load/store operation, a vector processing or matrix processing operation, etc.) and also provides various information directly attributed to the sampled operation. The capture of the sample record in the sample record storage is performed in hardware in the background of processing being performed on the pipeline 4, so does not require any specific software instructions to be executed to gather the information within the sample record.

The profiling circuitry 84 may filter the collection of the sample records in dependence on the SIMD processing configuration information 66. For example, the profiling circuitry 84 may produce the sample record in dependence on whether the processing circuitry 4 is operating in the first mode of operation (where the array size is determined by first array size defining state 62) or in the second mode of operation (where the array size is determined using second array size defining state 64), as described herein. The profiling circuitry 84 in some cases is responsive to the SIMD processing configuration information 66 specifying an array size with which SIMD processing is to be performed by the processing circuitry 4, to filter collection of the sample records based on the array size. Here, filtering the collection of the sample records may for example correspond to selectively suppressing or collecting the sample records based on the SIMD processing configuration information (e.g., array size/mode of operation) or the profiling circuitry 84 may determine an amount of information to include in the sample record in dependence on the SIMD processing configuration information.

The profiling circuitry 84 in some cases also includes information in the sample record relating to the array size with which SIMD operations were executed. The profiling circuitry 84 may include in the sample record an indication of the mode of operation or the array size used.

A sample record can be made accessible for diagnostic analysis by writing it to a profiling buffer structure stored in the memory system 30, 32, 34. The writing of the sample record to a profiling buffer in memory may be performed without needing to interrupt the processing on the pipeline 4, so that no specific software instructions are needed to cause the sample record to be stored to the memory system. Hence, a certain number of sample records can be output to the profiling buffer without any interrupts occurring, until sufficient number of sample records have been generated and written out that the profiling buffer risks overflowing, and at that point a performance monitoring interrupt could be triggered to cause the processing to be interrupted and so that the exception handler could then take action to ensure that the sample records previously stored to the profiling buffer can remain accessible for diagnostic analysis. Alternatively, the sample records could be output to a trace buffer which is a dedicated hardware structure separate from the memory system 30, 32, 34 for storing diagnostic information on-chip, and/or to output the captured sample record over a trace output port (either directly or via the trace buffer), where the trace output port is a set of integrated circuit pins via which the sample record can be output to an external off-chip trace analyser or storage device.

FIG. 10 illustrates an example of multiple processors 945, 940 sharing matrix processing circuitry 950. As shown in FIG. 10, there are two processors, CPU 0 940 and CPU 1 945. Each processor may contain all of the elements of FIGS. 1 and/or 9 although only the execution circuitry 16, 966 is depicted in FIG. 10. The execution circuitry 16, 966 contains a scalar processing unit 20, 970, a vector processing unit 22, 972 and a load/store unit 28, 978 as described above in relation to FIG. 1. Here however, the matrix processing functionality is provided by matrix processing circuitry 950, external to individual processors 940, 945. The matrix processing circuitry 950 is arranged to perform matrix processing and vector processing and has vector registers 952 and matrix registers 956 to store vector and matrix data respectively in order to support this processing. In some cases, the matrix processing circuitry 950 will be operable to perform all of the vector processing operations supported by the vector processing units 22, 972; however, in some cases, the matrix processing circuitry 950 may only support a more limited range of vector processing operations. Accordingly for those vector processing operations, the respective processors 940, 945 can use either their respective vector processing units 22, 972 or may use the matrix processing unit 950 via the matrix processing interfaces 924, 974. The use of the vector processing unit 22, 972 may correspond to one mode of operation as described herein with the use of the matrix processing unit 950 to perform vector processing corresponding to another mode of operation. One or both of the vector processing unit 22, 972 and the matrix processing units 950 may support a range of vector lengths (i.e., array sizes) for performing the vector processing with the vector length used dictated by the first array size defining state and the second array size defining state. It will be appreciated that the processing unit shared between the processors need not be the matrix processing unit. For example, the processors in some examples may each be provided with a dedicated vector processing unit as well as access to a shared vector processing unit. Indeed, various arrangements of SIMD processing units may be made in which one or more SIMD processing unit is shared between multiple processors.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Also, FIG. 11 illustrates a simulator implementation that may be used. Whilst the earlier described embodiments implement the present invention in terms of apparatus and methods for operating specific hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 930, optionally running a host operating system 920, supporting the simulator program 910. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 930), some simulated embodiments may make use of the host hardware, where suitable.

The simulator program 910 may be stored on a computer-readable storage medium (which may be a non-transitory medium), and provides a program interface (instruction execution environment) to the target program code 900 (which may include applications, operating systems and a hypervisor) which is the same as the interface of the hardware architecture being modelled by the simulator program 910. Thus, the program instructions of the target code 900, including instructions for setting the mode of operation, may be executed from within the instruction execution environment using the simulator program 910, so that a host computer 930 which does not actually have the hardware features of the apparatus 2 discussed above can emulate these features. The functions of diagnostic information collection circuitry 60 can be emulated by corresponding program logic 916. By providing a simulation of the apparatus shown in FIG. 1 in a software form, this can allow debugging software for interacting with the diagnostic information collection circuitry 60 to be developed before the hardware is actually available.

Hence, the simulator program 910 may have processing program logic 912 which simulates the state of the processing circuitry 4 described above. For example the processing program logic 912 may control transitions of execution state (e.g. exception level, operating mode) in response to events occurring during simulated execution of the target code 900. Instruction decoding program logic 914 decodes instructions of the target code 900 and maps these to corresponding sets of instructions in the native instruction set of the host apparatus 930. The register simulation logic 913 maps register accesses requested by the target code to accesses to corresponding register-emulating data structures 933 maintained by the host hardware of the host apparatus 930, such as by accessing data in registers or memory 932 of the host apparatus 930. Memory management program logic 915 implements address translation, page table walks and access control checking in a corresponding way to an MMU in a hardware-implemented embodiment, but also has the additional function of mapping simulated physical addresses obtained by the simulated MMU 915 to host virtual addresses used to access host memory 932. These host virtual addresses may themselves be translated into host physical addresses using the standard address translation mechanisms supported by the host (the translation of host virtual addresses to host physical addresses being outside the scope of what is controlled by the simulator program 910). Hence, the simulated physical address space accessed by the target code 900 can be mapped to a region 934 of host memory 932 representing the simulated target memory 8, 30, 32, 34 of the target processing apparatus 2 being simulated by the simulation program 910. This simulated target address space 934 may be used to store diagnostic information 935 that would be read out to the memory system 8, 30, 32, 34 in a corresponding hardware apparatus, e.g., from diagnostic information stored on the chip and represented by the simulated diagnostic information storage 936.

The simulator program 910 has diagnostic information collection program logic 916 which simulates the behaviour of the diagnostic information collection circuitry 60.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative examples of the invention have been described in detail herein with reference to the accompanying drawings, it is to be understood that the invention is not limited to those precise examples, and that various changes and modifications can be effected therein by one skilled in the art without departing from the scope and spirit of the invention as defined by the appended claims.

1. An apparatus comprising:
processing circuitry operable to perform single instruction, multiple data (SIMD) processing on an array comprising a plurality of data items, the processing circuitry supporting the SIMD processing for a plurality of array sizes;
wherein the processing circuitry is configured to select an array size with which to perform the SIMD processing based at least in part on SIMD processing configuration information;
diagnostic information collection circuitry to collect diagnostic information about software executing on the processing circuitry;
wherein the diagnostic information collection circuitry is configured to filter collection of the diagnostic information based on the SIMD processing configuration information.

2. The apparatus according to claim 1, wherein:
filtering the collection of the diagnostic information based on the SIMD processing configuration information comprises collecting or suppressing the collection of the diagnostic information in dependence on the SIMD processing configuration information.

3. The apparatus according to claim 1, wherein:
the processing circuitry is operable in a first mode of operation in which the processing circuitry is arranged to perform the SIMD processing with an array size determined based on first array size defining state and a second mode of operation in which the processing circuitry is arranged to perform the SIMD processing with an array size determined based on second array size defining state;
the SIMD processing configuration information is indicative of whether the SIMD processing circuitry is operating in the first mode of operation or the second mode of operation; and
the diagnostic information collection circuitry is configured to filter collection of the diagnostic information based on whether the processing circuitry is operating in the first mode of operation or the second mode of operation.

4. The apparatus according to claim 3, wherein the diagnostic information collection circuitry is configured to include, in the diagnostic information collected for the SIMD processing, an indication of whether the processing circuitry is operating in the first mode of operation or the second mode of operation.

5. The apparatus according to claim 1, the apparatus further comprising:
mode filter configuration storage circuitry to store a mode filter configuration status;
wherein the diagnostic information collection circuitry is responsive to the mode filter configuration status having a first value to collect the diagnostic information when the processing circuitry is in the first mode of operation and to suppress collection of the diagnostic information when the processing circuitry is in the second mode of operation.

6. The apparatus according to claim 5, wherein the diagnostic information collection circuitry is responsive to the mode filter configuration status having a second value to collect the diagnostic information when the processing circuitry is in the second mode of operation and to suppress collection of the diagnostic information when the processing circuitry is in the first mode of operation.

7. The apparatus according to claim 5, wherein the diagnostic information collection circuitry is responsive to the mode filter configuration status having a third value to collect the diagnostic information both when the processing circuitry is in the first mode of operation and when the processing circuitry is in the second mode of operation.

8. The apparatus according to claim 1, wherein:
the processing circuitry is arranged to perform the SIMD processing with an array size specified by the SIMD processing configuration information; and
the diagnostic information collection circuitry is configured to filter collection of the diagnostic information based on the array size specified by the SIMD processing configuration information.

9. The apparatus according to claim 1, wherein the diagnostic information collection circuitry is configured to include, in the diagnostic information collected for the SIMD processing, the array size with which the SIMD processing was performed.

10. The apparatus according to claim 1, further comprising array size filter configuration storage circuitry to store an array size filter configuration status, wherein:
the diagnostic information collection circuitry is responsive to the array size filter configuration status indicating that diagnostic information is to be collected for a particular array size with which the processing circuitry is performing the SIMD processing, to collect the diagnostic information; and
the diagnostic information collection circuitry is responsive to the array size filter configuration status specifying that diagnostic information is to be collected for one or more array sizes other than the particular array size with which the processing circuitry is performing the SIMD processing circuitry, to suppress the collection of the diagnostic information.

11. The apparatus according to claim 1, wherein:
the diagnostic information collection circuitry comprises performance monitoring circuitry for monitoring performance of the software executing on the processing circuitry;
the performance monitoring circuitry comprises a plurality of event counters, each to maintain a respective event count value based on monitoring of events during execution of the software on the processing circuitry;
the diagnostic information collection circuitry comprises control circuitry to configure the event counters based on counter configuration information, the counter configuration information comprising filter configuration information; and
the performance monitoring circuitry is configured to filter updates to the given event counter for events based on the filter configuration information and the SIMD processing configuration information.

12. The apparatus according to claim 1, the apparatus further comprising:
sampling circuitry to select a subset of instructions or micro-operations processed by the processing circuitry as sampled operations to be profiled; and
profiling circuitry to capture, in response to processing of an instruction or micro-operation selected as a sampled operation by the sampling circuitry, a sample record comprising diagnostic information indicative of the behaviour of the sampled operation.

13. The apparatus according to claim 12, wherein the profiling circuitry is configured to include in the sample record, an indication of at least part of the SIMD processing configuration information.

14. The apparatus according to claim 12, wherein the profiling circuitry is configured to selectively suppress the capture of a sample record in dependence on the SIMD processing configuration information.

15. The apparatus according to claim 3, wherein the processing circuitry is configured to use first SIMD processing circuitry to perform the SIMD processing in the first mode of operation and to use second SIMD processing circuitry to perform the SIMD processing in the second mode of operation.

16. (canceled)

17. (canceled)

18. (canceled)

19. The apparatus according to claim 15, wherein:
at least one of the first SIMD processing circuitry and the second SIMD processing circuitry is shared between a plurality of processors.

20. An apparatus comprising:
the apparatus according to claim 15;
the first SIMD processing circuitry; and
the second SIMD processing circuitry.

21. A non-transitory computer-readable medium to store computer-readable code for fabrication of the apparatus according to claim 1.

22. A method for collecting diagnostic information, the method comprising:
collecting the diagnostic information about software executing on processing circuitry;
wherein the processing circuitry is operable to perform single instruction, multiple data (SIMD) processing on an array comprising a plurality of data items, the processing circuitry supporting the SIMD processing for a plurality of array sizes, wherein the processing circuitry is configured to select an array size with which to perform the SIMD processing based at least in part on the SIMD processing configuration information; and
wherein collecting the diagnostic information comprises filtering collection of the diagnostic information based on the SIMD processing configuration information.

23. A non-transitory computer-readable medium storing a computer program comprising instructions which, when executed by a host data processing apparatus, control the host data processing apparatus to provide an instruction execution environment for executing target program code, the computer program comprising:
processing program logic operable to perform single instruction, multiple data (SIMD) processing on an array comprising a plurality of data items, the processing program logic supporting the SIMD processing for a plurality of array sizes;
wherein the processing program logic is configured to select an array size with which to perform the SIMD processing based at least in part on SIMD processing configuration information;
diagnostic information collection program logic to collect diagnostic information about software executing on the processing program logic;
wherein the diagnostic information collection program logic is configured to filter collection of the diagnostic information based on the SIMD processing configuration information.

24. (canceled)
